(19) United States
(12) Patent Application Publication
(10) Pub. No.: US 2021/0206060 A1
(43) Pub. Date: Jul. 8, 2021

(54) FUSING BUILD MATERIAL

(71) Applicant: HEWLETT-PACKARD DEVELOPMENT COMPANY, L.P., Spring, TX (US)

(72) Inventors: Luis GARCIA, Sant Cugat del Valles (ES); Alejandro Manuel DE PENA, Sant Cugat del Valles (ES); Alejandro BONILLO, Sant Cugat del Valles (ES)

(73) Assignee: HEWLETT-PACKARD DEVELOPMENT COMPANY, L.P., Houston, TX (US)

(21) Appl. No.: 16/089,512

(22) PCT Filed: Apr. 11, 2017
(86) PCT No.: PCT/US2017/027005

§ 371 Date: Sep. 28, 2018

(51) Int. Cl. B29C 64/165; B29C 64/393; B29C 64/245

(52) U.S. Cl. CPC B29C 64/165; B33Y 10/00; B29C 64/245; B29C 64/393

(57) ABSTRACT

An additive manufacturing system is described. The system includes a working area with a moveable platform, a supply mechanism to supply a build material to the working area, a radiation source to apply energy to the working area during construction of an object, so as to fuse at least a portion of the build material, a platform advance sensor to determine a displacement of the platform in at least a direction perpendicular to the plane of the platform, and a radiation source controller to adjust the energy applied by the radiation source based on the displacement measured by the platform advance sensor.

### BACKGROUND

Additive manufacturing systems, including those commonly referred to as “3D printers”, provide a convenient way to produce three-dimensional objects. These systems may receive a definition of a three-dimensional object in the form of an object model. This object model is processed to instruct the system to produce the object using one or more material components. This may be performed on a layer-by-layer basis in a working area of the system. Chemical agents, referred to as “printing agents”, may be selectively deposited onto each layer within the working area. In one case, the printing agents may comprise a fusing agent and a detailing agent, among others. Energy may be applied using a radiation source, such as an infrared lamp, to fuse areas of a layer where fusing agent has been deposited. The process may be repeated for further layers to build up a final object.

### BRIEF DESCRIPTION OF THE DRAWINGS

Various features of the present disclosure will be apparent from the detailed description which follows, taken in conjunction with the accompanying drawings, which together illustrate, by way of example, features of the present disclosure, and wherein:

FIGS. 1A, 1B and 1C are schematic diagrams showing components of an additive manufacturing system according to an example;

FIGS. 2A and 2B are schematic diagrams showing components of an additive manufacturing system according to another example;

FIG. 3A is a flow diagram showing a method of generating a three-dimensional object with an additive manufacturing system according to an example;

FIG. 3B is a flow diagram showing a method of computing a correction factor according to an example; and

FIG. 4 is a schematic diagram showing a computing device according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

In the production of three-dimensional objects, e.g. in so-called “3D printing”, there is a challenge to produce objects with good structural integrity and aesthetic appearance. Print errors, such as sub-optimally fused layers, may result in a product with a reduced structural integrity and/or an undesirable appearance.

In some cases, sub-optimally fused layers may be a result of applying too much or too little energy to a layer of build material to be fused. For example, applying too much energy to a layer of build material may result in thermal bleed, hot spots, bed cracks, and/or extrusions in at least a layer of a final object. Applying too little energy may result in deformations and/or warpage. This may occur when energy is applied to a layer of build material without taking into account the properties of the layer. To produce objects with good structural integrity and aesthetic appearance, it is thus desired to apply a correct amount of energy to a layer of build material.

In certain additive manufacturing systems, it is also found that the thickness of build material layers may vary from layer to layer due to factors beyond a user's control. For example, a platform supporting a set of build material layers may not advance as intended—this may be referred to as a platform advance error. Alternatively or additionally, it may be desired to produce objects comprising layers of a variety of thicknesses, wherein the additive manufacturing system provides fusing energy suitable for fusing build material layers of a variety of thicknesses.

When applying energy to a layer of build material, it is noted that the amount of energy to fuse the layer may depend on a thickness of the layer: the thicker the layer, the more energy, and vice versa. In certain additive manufacturing systems, energy is applied to a build material layer through fixed radiation sources such as infrared lamps. In these cases, the energy that is applied is not modulated based on the thickness of the layer, i.e., a fixed amount of energy is applied to the build layer regardless of its thickness. Accordingly, print errors observed in three-dimensional objects produced by these systems may derive from applying too much or too little energy from a fusion source to a layer of build material to be fused, because the thickness of the build material layer varies from an expected thickness.

To help provide objects with good structural integrity and aesthetic appearance, certain examples described herein modulate an amount of energy to be applied to a build material layer according to the thickness of the build material layer. This may allow the reduction of unwanted print errors, such as “stair-stepping” or “stair-casing”.

Furthermore, certain examples described herein may be used to accurately determine a thickness of a layer of unfused build material without directly measuring the layer thickness, e.g. without expensive optical and/or topological measuring devices. In these examples, the layer thickness may be determined indirectly, by measuring mechanical properties of the additive manufacturing system (for example, the displacement of a platform, or rotation of a screw) and processing that measurement to determine the layer thickness. These indirect methods of determining layer thickness may be simpler and more cost-effective than comparative methods. Additionally, certain comparative methods of determining layer thickness may depend on the nature of the build material. Certain, indirect methods of determining layer thickness as described herein are independent of the nature of the build material.

In examples described herein, a working area of an additive manufacturing system is defined as an area in which build material is deposited and fused in order to make a three dimensional object. The working area may be referred to as a print bed. The working area comprises a moveable platform. An initial layer of build material is deposited on the moveable platform in the working area, and successive layers of build material are deposited on top of the build material in the working area on the moveable platform over the course of production. In some examples, before or after the deposition of each build material layer, the platform advances in a direction (e.g. up or down) to allow for the deposition of further build material.

In certain examples described herein, a layer thickness is indirectly determined by measuring the displacement of the working area platform. This measurement may then be used to adjust an amount of energy to be applied to the layer. For example, a displacement of the platform may be determined by a platform advance sensor. The platform advance sensor should be sufficiently accurate to measure displacement of the platform, e.g. in the order of at least 100 μm, or 10 μm, or 1 μm. A platform advance sensor may directly measure the displacement of the platform, and may be, for instance, an inductive sensor (such as an eddy current sensor), a capacitive displacement sensor, or a photoelectric sensor (such as a laser rangefinder). In other examples, a platform advance sensor may indirectly measure the displacement of the platform, for instance by measuring a rotation of a shaft driving the working area platform.

Certain examples described herein are particularly suited to additive manufacturing systems that use a powdered build material. In these cases, a region above the working area may contain, in use, a suspension of build material particles, e.g. in the form of build material dust in a volume of air. Build material dust may occur after supplying build material to the working area. Such build material particle suspensions negatively impact an efficacy of directly measuring a build material layer. For example, optical measurements may be negatively affected. Such a suspension of build material particles may not affect the accuracy or efficacy of methods of indirectly determining the unfused build material layer thickness.

In certain examples described herein, an additive manufacturing system comprises a radiation source for applying energy to the working area. The radiation source may supply energy, in use, to the working area such that at least a portion of build material present in the working area is fused. Certain methods described herein adjust the energy applied by the radiation source based on a measurement of layer thickness, e.g. from a platform advance sensor.

In some examples, the radiation source may be a focused energy source, arranged to apply energy to localized areas of the working area. For instance, the radiation source may be a laser source. Focused energy sources according to certain examples described herein may emit radiation in the ultraviolet range, or the visible light range, or the infrared range, or a combination thereof. In other examples, the radiation source may be a non-focused energy source. For example, the radiation source may comprise an infrared energy source (for example, a short wave incandescent lamp). The radiation source may provide energy to substantially all of the working area at substantially the same time. For example, a bulk-fusion energy source may be a static source. In other examples, a radiation source may provide energy to successive sections of the working area; that is, the radiation source may comprise a scanning source that scans across the working area to provide energy to the working area. In both case, the energy applied by such a radiation source to the working area may be substantially uniform across the working area. In examples where the radiation source scans across the working area, the cumulative energy applied across the working area after one scan of the radiation source across the whole of the working area may be substantially uniform across the working area. In both cases, the energy absorbed by the build material from the energy source is sufficient to fuse at least a portion of the build material to which a fusing agent has been applied. The radiation source may emit radiation across a broad range of wavelengths, the radiation having wavelengths of from about 700 nm to 1 mm, or from 700 nm to 100 μm, or from 750 nm to 5 μm.

Certain examples will now be described in more detail with reference to the Figures.

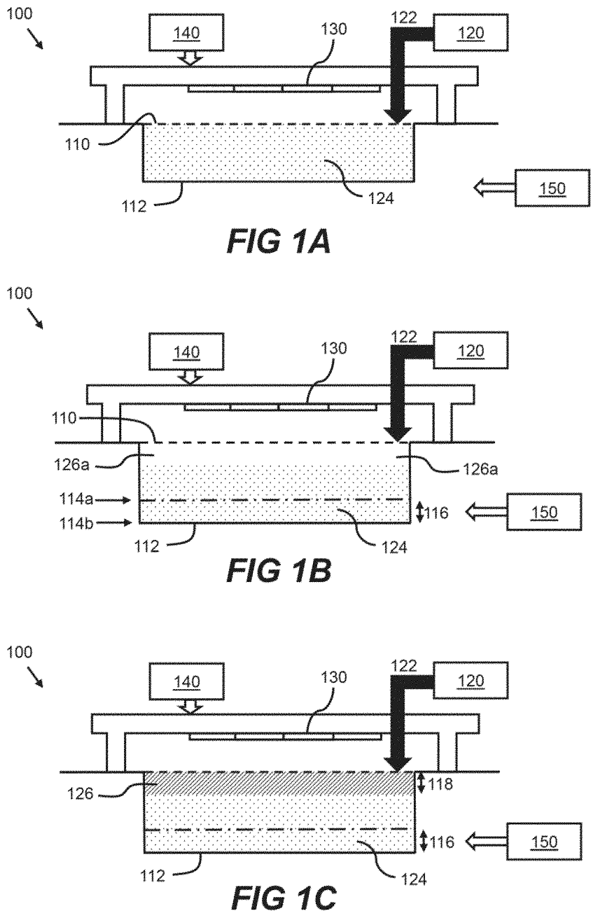

FIGS. 1A to 1C show an additive manufacturing system 100 according to an example. The additive manufacturing system 100 comprises a working area 110 where a three-dimensional object is constructed. The working area comprises a moveable platen, base or platform 112. FIGS. 1B and 1C demonstrate how the platform may move in use. In FIG. 1A, the additive manufacturing system 100 also comprises a supply mechanism 120 to deposit layers of build material 122 within the working area 110. The supply mechanism 120 may comprise at least one of a build material supply, a build material preconditioning system, a build material spreading system, and a power advance system. The build material 122 may comprise a polymer powder (or slurry, paste, gel etc.). The supply mechanism 120 may supply build material 122 to provide a build material layer of substantially uniform thickness in the working area. In an example, the thickness of the build material layer may correspond to the distance between the surface on which the build material layer was deposited and the top of the working area. In use, layers of build material are fused, as indicated by layer 124.

In FIG. 1A, the additive manufacturing system 100 comprises a radiation source 130 arranged to apply energy to fuse portions of the three-dimensional object. For example, build material 122 as supplied from the supply mechanism 120 to the platform 112 of the working area 110 may be fused, at least in certain areas, to form a fused layer 124. The radiation source 130 may be mounted above the working area and may comprise an infrared energy source. In certain examples, the radiation source 130 may travel or scan across the working area 110. The radiation source 130 is coupled to a radiation source controller 140. The radiation source controller 140 controls the amount of energy applied by the radiation source 130. For example, the radiation source controller 140 may control a pulse width modulation and/or scanning rate of the radiation source 130.

Lastly, in FIG. 1A, the additive manufacturing system 100 comprises a platform advance sensor 150. The platform advance sensor 150 is arranged to determine a displacement of the platform 112 in at least a direction perpendicular to the plane of the platform relative to at least one of the supply mechanism 120 and the radiation source 130. The operation of the platform advance sensor 150 is described in more detail below with reference to FIGS. 1B and 1C.

Within the additive manufacturing system 100 shown in FIG. 1A, the radiation source controller 140 is configured to adjust the energy applied by the radiation source 130 based on a displacement measured by the platform advance sensor 150. In this case, the displacement measured by the platform advance sensor 150 is used to indirectly measure a height of a build material layer upon the platform 112 of the working area 110.

FIGS. 1A to 1C show how a three-dimensional object undergoing additive manufacture may be built layer-by-layer within the working area 110.

In use, following application of energy to fuse at least portions of a build material layer, the platform 112 may be advanced in a direction perpendicular to the plane of the platform. For example, FIG. 1B shows the additive manufacturing system 100 wherein the platform 112 has been advanced from a first position 114a to a second position 114b. In this example, the platform 112 has been advanced relative to at least one of the supply mechanism 120 and the radiation source 130. The advance of platform 112 from first position 114a to second position 114b provides a hollow or empty portion 126a at the top of the working area 110. In moving from first position 114a to second position 114b the platform 112 advances a distance 116. This distance 116 is measured by the platform advance sensor 150.

The platform advance sensor 150 may be any sensor which may determine the displacement of the platform 112, including any of those described hereinabove. The terms “distance”, “distance travelled” and “displacement” may be used interchangeably to refer to the difference between a first position and a second position of the platform, such as distance 116.

In use, supply mechanism 120 may supply build material 122 to the working area 110, thereby depositing build material 122 onto the upper surface of the build material already disposed. For example, FIG. 1C shows a layer of unfused build material 126 deposited onto the upper surface of the build material 124 already disposed on the platform 112, i.e. deposited in the hollow portion 126a shown in FIG. 1B. The build material 122 may be deposited such that the unfused build material layer 126 is of substantially uniform thickness 118, the thickness 118 being the distance between the upper and lower faces of the unfused build material layer 126 which are coplanar with the plane of the platform 112.

In an example, the thickness 118 of the unfused build material layer 126 corresponds to the distance 116 travelled by the platform 112. Thus, the distance 116 measured by the platform advance sensor 150 is used to adjust the energy applied by the radiation source 130 to the build material layer, thereby taking into account the thickness of the build material layer. This system thus accurately applies energy in proportion to a thickness of a build material layer without expensive or complex measuring devices.

In certain examples, the additive manufacturing system further comprises a printing agent deposit mechanism. The printing agent deposit mechanism may be mounted above the working area 110 to selectively deposit one or more printing agents to portions of the build material in the working area 110. These printing agents may be deposited to control fusion of areas of the build material layer, e.g. they may be used to indicate areas to fuse or areas not to fuse.

The printing agent deposit mechanism may comprise a plurality of printheads, each configured to deposit particular print agent(s). Each printhead may comprise a thermal or piezo printhead. The printing agent deposit mechanism may comprise a scanning mechanism, such as a carriage or the like, or a single printhead die, e.g. which extends across a width or height of the working area 110. In certain cases, the printing agent deposit mechanism may be configured to move relative to the working area, e.g. scan above the working area in one or more dimensions.

The printing agents deposited by the printing agent deposit mechanism may be a composition which can be used to modify a degree of fusing of a portion of build material in a portion of the working area, upon application of energy to the working area, i.e. a portion on which the printing agent has been deposited. A printing agent may comprise a fusing agent, a detailing agent and/or a functional agent.

A fusing agent may be applied to a layer of build material to enable fusing of defined areas of the layer following the application of fusing energy. Similarly, in certain cases, a detailing agent may be applied to areas of a layer of build material, for example to inhibit, or modify a degree of fusing. In an example, the detailing agent may reflect infrared radiation. A detailing agent may comprise titanium dioxide, for example.

For the avoidance of doubt, a fusing agent is different from a binding material (or “binder”) in that a fusing agent acts as an energy absorbing agent that causes build material on which it has been deposited to absorb more energy than the build material would absorb in the absence of fusing agent. A binding material or binder, on the other hand, chemically acts to draw build material together to form a cohesive whole. In an example, the fusing agent may absorb infrared radiation. A fusing agent may comprise carbon black, for example. Fusing agent may be selectively deposited in the working area so that only selected portions of the build material fuse when energy is applied.

A functional agent may be applied to a layer of build material to define areas which are to have different object properties. Objects produced from a single, bulk build material necessarily may have a limited variety of physical properties due to the homogeneity of the object structure. Providing a functional agent, though, may be used to introduce properties beyond those which can be provided by a single build material alone. In certain examples, the functional agent may provide the three dimensional object with one or more of the following specified properties: material properties, mechanical properties, physical properties such as color, detail, flexibility, surface texture, conductivity, and magnetism. Certain examples of functional agents include metallic loaded inks, or plasticizers.

In certain examples, the radiation source 130 may be configured to scan across the working area 110 in a direction orthogonal to the movement of the printing agent deposit mechanism. As such both the printing agent deposit mechanism and the radiation source 130 may be arranged to scan above the surface of the working area.

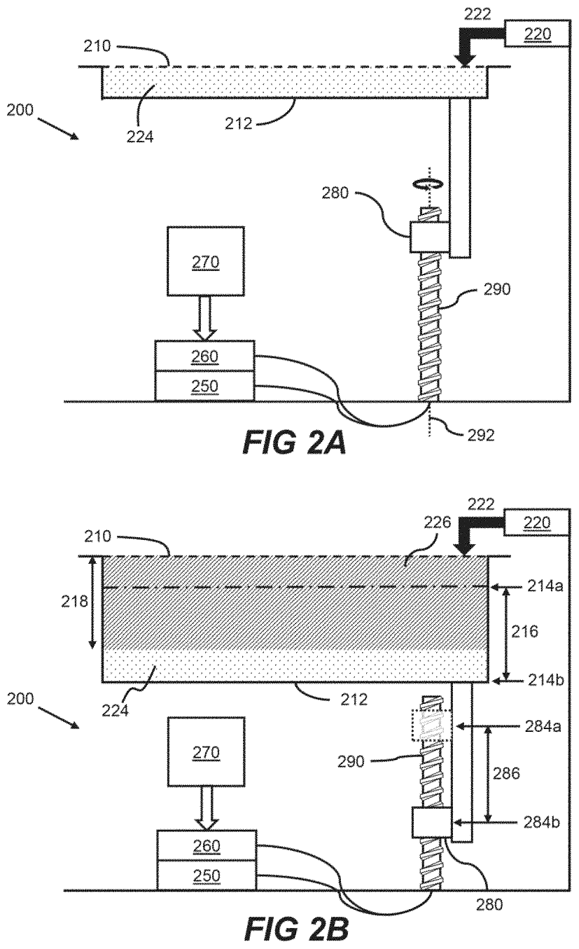

FIGS. 2A and 2B show an additive manufacturing system 200 according to another example. For brevity, features in FIGS. 2A and 2B and the functions thereof that are the same as those features already described with reference to FIGS. 1A, 1B and 1C are given similar reference numerals to those in FIGS. 1A, 1B and 11C but increased by 100.

In FIGS. 2A and 2B, a working area platform 212 comprises a threaded aperture 280. A suitable threaded aperture 280 may be a nut, and comprises an internal (or “female”) thread. The threaded aperture 280 may be immovably fixed relative to the platform 212. In particular, the threaded aperture 280 may be non-rotatable relative to the platform 212.

The term “thread” as used herein refers to a helical structure used to convert between rotation and linear movement or force. In an example, a thread may be formed as a ridge on a surface in the form of a helix.

The additive manufacturing system 200 may comprise a threaded elongate member, shank, or shaft 290. A suitable threaded elongate member 290 may be a bolt, and comprises an external (or “male”) thread. The threaded elongate member 290 may be arranged in the additive manufacturing system in a fixed position relative to the supply mechanism 220. Nevertheless, the threaded elongate member 290 may be rotatable around its longitudinal axis (co-axial with the direction of the thread of the elongate member 290).

The threaded elongate member 290 may be arranged within the threaded aperture 280. The threaded elongate member 290 and the threaded aperture 280 may be arranged such that the threads engage, and rotation of the threaded elongate member 290 about its axis 292 results in movement of the threaded aperture 280 along the threaded elongate member's rotatable axis 292. In an example where the threaded aperture 280 is immovably fixed relative to the platform 212, rotation of the threaded elongate member 290 about its axis 292 results in movement of the threaded aperture 280 and thus the platform 212 along the threaded elongate member's rotatable axis 292. For example, the platform 212 may be slideably mounted within a frame of the additive manufacturing system and moved up and down via rotation of the threaded elongate member 290.

According to the example shown in FIGS. 2A and 28, the platform 212, threaded aperture 280 and threaded elongate member 290 are arranged such that movement of the threaded aperture 280 and platform 212 along the threaded elongate member's rotatable axis 292 corresponds to movement in a direction perpendicular to the plane of the platform 212.

The threaded elongate member 290 may be left handed or right handed. According to the example shown in FIGS. 2A and 2B, wherein the threaded elongate member 290 is shown having a right-handed thread, rotation of the threaded elongate member 290 around its axis 292 in a clockwise direction advances platform 212 in the direction perpendicular to the plane of the platform towards the supply mechanism 220 (as in, as seen in the context of FIGS. 2A and 2B, the platform 212 advances upwards). Conversely, rotation of the threaded elongate member 290 around its axis 292 in a counter-clockwise direction advances platform 212 in the direction perpendicular to the plane of the platform away from the supply mechanism 220 (as in, as seen in the context of FIGS. 2A and 2B, the platform 212 advances downwards). For example, to advance from FIG. 2A to 2B, the threaded elongate member 290 of FIG. 2A is rotated in a counter-clockwise direction to advance the platform 212 from a first position 214a to a second position 214a away from the supply mechanism.

The distance that the platform 212 advances will depend on the degree of rotation of threaded elongate member 290 about axis 292 and the pitch/lead of the threaded aperture 280 and threaded elongate member 290. The lead of the thread in the present example is the linear distance which is travelled by the threaded aperture 280 as a result of one revolution of the threaded elongate member 290. The lead of the thread may be any suitable distance. In an example, the lead is from 0.1 mm to 10 mm, or from 0.5 mm to 5 mm, or about 3 mm.

As shown in FIG. 2B, once the platform 212 advances downwards, build material 222 may be deposited to the working area 210 to provide a layer of unfused build material 226, having substantially uniform thickness 218. The displacement 216 of the platform 212 in advancing from the first position 214a to the second position 214b may correspond to the thickness 218 of the build material layer 226. Further, the displacement 286 of the threaded aperture 280 from a first position 284a to a second position 284b may correspond to the displacement 216 of the platform 212, and thus the thickness 218 of the build material layer 226. As described herein above, the displacement of the threaded aperture 280 and platform 212 may correspond to the degree of rotation and lead of the threaded elongate member 290.

In FIGS. 2A and 2B, the additive manufacturing system 200 comprises a platform advance sensor 250. In this example, the platform advance sensor 250 is configured to measure the rotation of the threaded elongate member 290. Thus, the platform advance sensor 250 determines the distance travelled by the platform in at least a direction perpendicular to the plane of the platform by measuring the rotation of the threaded elongate member.

In one example, the platform advance sensor 250 is a rotary encoder. The platform advance sensor 250 may be an optical or a magnetic sensor. Optical sensors include reflective sensors, interrupter sensors, and optical encoders. In an example, the platform advance sensor 250 is an optical rotary encoder. Such rotary encoders may be used with an optical radius codewheel. Magnetic sensors include variable-reluctance (VR) sensors, eddy-current killed oscillators (ECKO), Wiegand sensors, and Hall-effect sensors.

The platform advance sensor 250 is configured to have a resolution sufficient to allow accurate determination of the displacement of the platform 212. For example, a rotary encoder (and radius codewheel, where appropriate) employed as the platform advance sensor 250 may have a resolution of at least 1000, 1024, 2000, or 2048 CPR (counts per revolution). In some examples, the platform advance sensor 250 may have a resolution greater than 2048 CPR.

The threaded elongate member may be rotated about its longitudinal axis. In an example, the additive manufacturing system 200 comprises an actuator 260, such as a rotary actuator. The actuator 260 is arranged to provide torque to the threaded elongate member 290, causing the member 290 to rotate about its axis.

The actuator 260 may be controlled by an actuator controller 270. The controller 270 may be configured to control the degree of torque provided by the actuator 260 to the threaded elongate member 290, thereby controlling the rotation of the threaded elongate member 290. The controller 270 may instruct the actuator so as to move the platform 212 a predetermined distance. In some examples, factors beyond the control of the user (such as variation in the manufacture of components of the additive manufacturing system 200) may mean that, despite the controller 270 controlling the degree of torque applied by actuator, the distance travelled by the platform 212 may not directly correspond to the predetermined distance instructed by the controller 270.

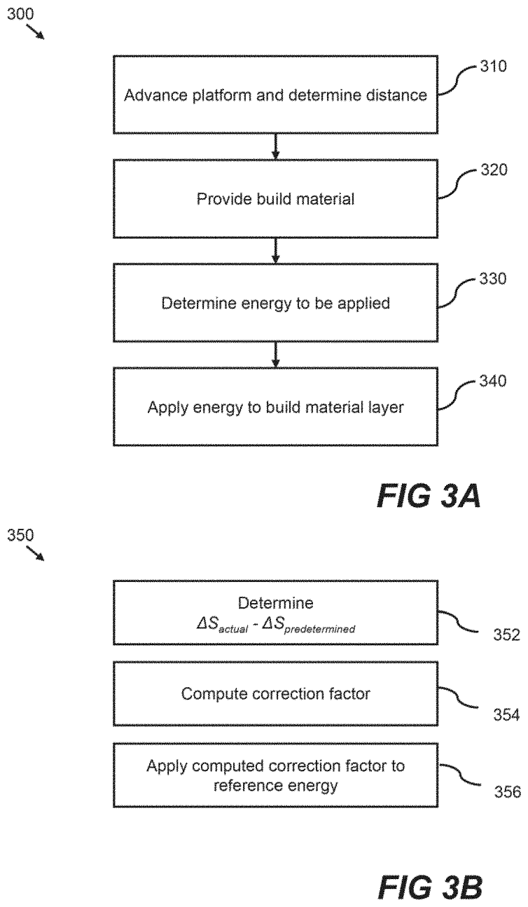

FIG. 3A is a flow diagram showing a method of generating a three-dimensional object 300. In this example, the method 300 comprises advancing a platform providing a working area of the additive manufacturing system, including determining the distance travelled by the platform in a direction perpendicular to the plane of the platform 310. In an example (for instance, in an example wherein the additive manufacturing system corresponds to the additive manufacturing system 200 of FIGS. 2A and 2B), the platform may be advanced by rotating a threaded elongate member in a threaded aperture which is in a fixed position relative to the platform, the threaded elongate member being arranged in and engaging with the threaded aperture. In this example, the distance travelled by the platform may be determined by measuring the rotation of the elongate member in the threaded aperture. The distance may be determined using any of the sensors and techniques described hereinabove.

Returning to FIG. 3A, at block 320, build material is provided to the working area to provide a build material layer 320. For example, build material may be deposited on the platform, or upon a previously layer of build material. One or more rollers or brushes may be supplied to evenly distribute the build material over the working area. In the present case, the build material layer provided has a thickness proportional to the distance travelled by the platform as it was advanced in block 310.

At block 330, the method comprises determining an amount of energy to be applied by a radiation source of the additive manufacturing system. The amount of energy is based on the distance determined in block 310. This amount of energy may be represented as a particular irradiance value, e.g. in W/m, and/or a configuration of the radiation source that provides such a value, e.g. in terms of an applied power level.

At block 340, the method comprises applying the determined amount of energy to the build material layer using the radiation source, thereby fusing at least a portion of the build material. In an example, the energy is applied substantially uniformly across a surface of the build material layer. For instance, the energy may be applied by a lamp fixed above the working area, or a lamp fixed to a carriage. The energy is applied based on the settings determined at block 330.

In certain examples, the method may comprise a further block of selectively depositing printing agent onto a portion of the build material layer. This further block may follow block 320. The printing agent may include a fusing agent, detailing agent and/or functional agent as described above. In some examples, deposition comprises depositing fusing agent on a portion of the build material layer. Alternatively or additionally, it may comprise depositing detailing agent on a portion of the build material layer. Alternatively or additionally, it may comprise depositing functional agent on a portion of the build material layer. Deposition of a plurality of printing agents may take place at substantially the same time, or may be staggered in time.

FIG. 3B is a further flow diagram showing operations that may be used to determine the energy to be applied at block 330 of FIG. 3A.

In an example, the amount of energy to be applied may be determined according to the following equation:

E_{determined}=α(ΔS_{determined}−ΔS_{predetermined})+E_{ref}

In this example, the platform of the additive manufacturing system is programmed to advance a predetermined or programmed distance (ΔS_{predetermined}). This distance has an associated reference energy value (E_{ref})—this is an amount of energy suitable for fusing a build material layer with a thickness corresponding to the predetermined distance. The predetermined distance is then compared with the actual displacement of the platform as determined by the platform advance sensor (ΔS_{determined}). The two distance values may differ. Accordingly, the amount of energy to be applied to the build layer (E_{determined}) is determined by determining the difference between the predetermined distance and the actual distance.

FIG. 3B shows a number of operations for evaluating the above equation. At block 352, a difference between the predetermined distance and the actual (measured) distance is determined. At block 354, a correction factor is computed based on the determined difference. Then at block 356, the computed correction factor is applied to a reference energy value. In an example, the correction factor is applied by summing the correction factor with the reference energy value to provide the determined energy to be applied.

The correction factor to be applied to the reference energy value may be a product of a constant (a) and the difference between the predetermined distance and the determined displacement (ΔS_{determined}−ΔS_{predetermined}). The constant a may be determined empirically. This example may be appropriate for providing good quality three-dimensional objects be addressing platform advance errors.

In another example (not shown), determining the energy to be applied to the build material layer at block 330 may comprise determining the displacement of the platform, and comparing the determined displacement with a database of predetermined energy values, the predetermined energy values corresponding to an amount of energy to be applied to a build material layer of a determined thickness.

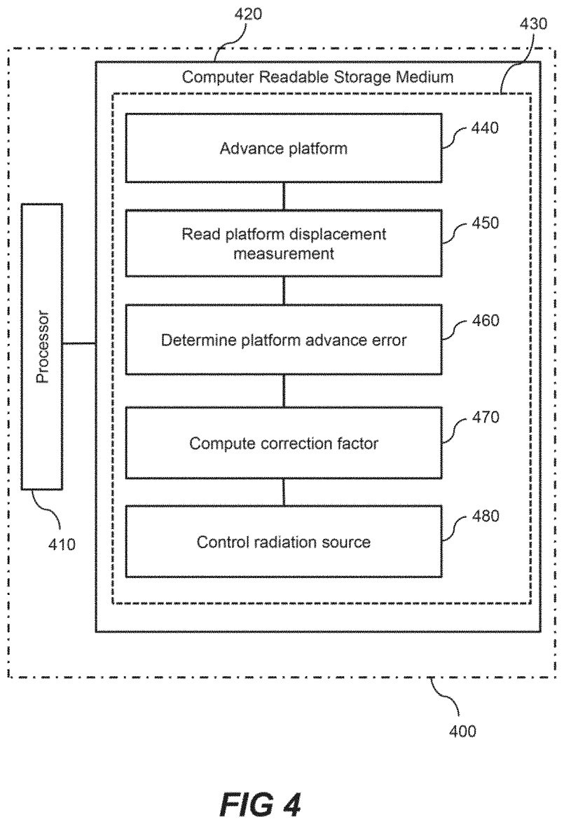

FIG. 4 is a schematic diagram showing a computing device 400 according to an example. According to one example, there is provided a non-transitory computer-readable storage medium 420 comprising a set of computer-readable instructions 430 stored thereon, which, when executed by a processor 410 of an additive manufacturing system, cause the processor to carry out a number of operations.

In FIG. 4, the instructions 430 first comprise an instruction 440 to control an actuator of the additive manufacturing system to advance a platform of the additive manufacturing system by a predetermined distance. In one example, the predetermined distance may be selected by a user. In another example, it may be selected based on an object to be printed, e.g. a defined print resolution in the z-axis. In one example, the predetermined distance may differ layer to layer. In another example, the predetermined distance may be substantially the same for each layer.

Via instruction 450, the processor may then read data comprising at least one platform displacement measurement from a platform advance sensor. In an example, the platform displacement measurement might not correspond to the predetermined distance instructed by instruction 440, for a number of factors beyond the user's control.

The platform displacement measurement may be provided as a linear distance, or a rotational displacement corresponding to the means of advancing the platform (for example, the rotation of the threaded elongate member of the example shown in FIGS. 2A and 2B). The computer-readable instructions 430 may further cause the processor to convert any platform displacement measurement read to a linear distance. The converted linear distance may correspond to the thickness of layer of build material to be fused.

Instruction 460 then instructs the processor to compare the predetermined distance with the platform displacement measurement from the platform advance sensor to compute a platform advance error. The platform advance error may comprise a difference between the predetermined distance and the platform displacement measurement (e.g. ΔS_{determined}−ΔS_{predetermined}). Instruction 470 may then instruct the processor to compute a correction factor for energy to be applied to a working area of the additive manufacturing system. The correction may be calculated with the equation set forth hereinabove, using the computed platform error, such that the correction factor is a (ΔS_{determined}-ΔS_{predetermined}).

Lastly instruction 480 instructs the processor to control a radiation source to apply a corrected amount of energy to the working area. The corrected amount of energy may be determined by applying the correction factor to a reference amount of energy according to the equation set forth hereinabove.

In one example, the computer device 400 may be arranged in a radiation source controller. In another example, a processor may control an actuator and read data comprising at least platform displacement measurement from a platform advance sensor as set out instructions 440 and 450. The processor may then compare the platform displacement measurement with a database, the database comprising predetermined energy values corresponding to travel distance measurements. That is, the database may contain data as to how much energy should be applied to a working area based on the thickness of a layer of build material. The processor may then control a radiation source to apply a corrected amount of energy to the working area. The corrected amount of energy may be determined by selecting the reference energy value corresponding to the platform displacement measurement from the database.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An additive manufacturing system comprising:
a working area including a moveable platform;
a supply mechanism to supply a build material to the working area;
a radiation source to apply energy to the working area during construction of an object, so as to fuse at least a portion of the build material;
a platform advance sensor to determine a displacement of the platform in at least a direction perpendicular to the plane of the platform; and
a radiation source controller to adjust the energy applied by the radiation source based on the displacement measured by the platform advance sensor.

2. The additive manufacturing system of claim 1, further comprising a printing agent deposit mechanism to selectively deliver printing agent to a portion of the working area, wherein the printing agent is a composition to modify a degree of fusing of build material in the portion of the working area upon application of energy to the working area.

3. The additive manufacturing system of claim 1, wherein the radiation source is an infrared energy source.

4. The additive manufacturing system of claim 1, wherein the radiation source is arranged to apply energy substantially uniformly across the working area.

5. The additive manufacturing system of claim 1, wherein:
the moveable platform comprises a threaded aperture which is immovably fixed relative to the moveable platform, the thread being arranged in a direction perpendicular to the plane of the platform; and
the additive manufacturing system comprises a threaded elongate member which is in a fixed position relative to the additive manufacturing system and is rotatable about its elongate axis;
wherein the threaded elongate member is arranged in and engages with the threaded aperture such that rotation of the threaded elongate member results in movement of the moveable platform in a direction perpendicular to the plane of the platform.

6. The additive manufacturing system of claim 5 comprising an actuator arranged to rotate the threaded elongate member, and an actuator controller configured to control the degree of torque provided by the actuator to the threaded elongate member, thereby controlling the rotation of the threaded elongate member.

7. The additive manufacturing system of claim 5, wherein the platform advance sensor is configured to determine the displacement of the platform in at least a direction perpendicular to the plane of the platform by measuring the rotation of the threaded elongate member.

8. The additive manufacturing system of claim 5, wherein the radiation source controller is configured to determine a correction factor for the radiation source based on data from the platform advance sensor and the actuator controller.

9. A method of generating a three-dimensional object with an additive manufacturing system, the method comprising:
advancing a platform providing a working area of the additive manufacturing system, including determining a displacement of the platform in a direction perpendicular to the plane of the platform;
providing a build material to the working area to provide a build material layer having a thickness proportional to the displacement;
determining an amount of energy to be applied by a radiation source of the additive manufacturing system based on the displacement; and
applying the determined amount of energy to the build material layer using the radiation source, thereby fusing at least a portion of the build material.

10. The method of claim 9, further comprising selectively depositing a printing agent onto a portion of the build material layer before applying the determined amount of energy to the build material layer, wherein the printing agent is a composition to modify a degree of fusing of the portion of the build material upon application of energy to the build material layer.

11. The method of claim 9, wherein the determined amount of energy is applied substantially uniformly across a surface of the build material layer.

12. The method of claim 9, wherein advancing the platform comprises rotating a threaded elongate member of the additive manufacturing system in a threaded aperture which is in a fixed position relative to the platform, the threaded elongate member being arranged in and engaging with the threaded aperture.

13. The method of claim 12, wherein determining the displacement of the platform comprises measuring the rotation of the elongate member in the threaded aperture.

14. The method of claim 9, wherein determining the amount of energy to be applied by the radiation source comprises:
comparing the determined platform displacement with a predetermined platform displacement to provide a correction factor, and applying the correction factor to a reference amount of energy; or
comparing the determined platform displacement with a database of predetermined energy values, the predetermined energy values corresponding to an amount of energy to be applied to a build material layer of a determined thickness, and selecting the predetermined amount of energy corresponding to the determined platform displacement.

15. A non-transitory computer-readable storage medium comprising a set of computer-readable instructions stored thereon, which, when executed by a processor of an additive manufacturing system, cause the processor to:
control an actuator of the additive manufacturing system to advance a platform of the additive manufacturing system by a predetermined distance;
read data comprising at least one displacement measurement from a platform advance sensor;
either
compute a correction factor for energy to be applied to a working area of the additive manufacturing system (460), the correction factor being calculated by comparing a predetermined distance with the displacement measurement from the platform advance sensor (460);
or
compare the displacement measurement with a database, the database comprising predetermined energy values corresponding to displacement measurements;
and
control a radiation source to apply a determined amount of energy to the working area, the determined amount of energy being determined by either:
applying the correction factor to a reference amount of energy;
or
selecting the reference energy value corresponding to the travel distance measurement.
